(19) United States
(12) Patent Application Publication
(10) Pub. No.: US 2024/0140715 A1
(43) Pub. Date: May 2, 2024

(54) SYSTEM OF AUTOMATED COLUMNS FOR VERTICAL WAREHOUSES

(71) Applicant: Pietro Laudani, Boleslawiec (PL)

(72) Inventor: Pietro Laudani, Boleslawiec (PL)

(21) Appl. No.: 18/276,444

(22) PCT Filed: Dec. 22, 2021
(86) PCT No.: PCT/IB2021/062194

§ 371 Date: Aug. 8, 2023

(30) Foreign Application Priority Data
Mar. 5, 2021 (IT) 21020126.5

(51) Int. Cl. B65G 1/14; B65G 47/51

(52) U.S. Cl. CPC B65G 1/14; B65G 47/5181

(57) ABSTRACT

A system of automated columns for a vertical warehouse having: —a plurality of automated columns (10) integrally connected to a framed structure, the number of columns being always even, each of said plurality of automated columns having in turn a transmission member which rotates around an upper gear assembly and a lower gear assembly and a plurality of supports, supported by the transmission member, which translate from top to bottom and vice versa by the rotational movement of the transmission member, —a pneumatic/electrical or mechanical drive—a plurality of mechanical transmissions (130) in a number equal to the number of columns—the pneumatic/electrical or mechanical drive and mechanical transmissions synchronize the upward or the downward movement of the plurality of supports that support corresponding components to be stored, and—the plurality of mechanical transmissions comprises a corresponding plurality of cardan joints.

### BACKGROUND OF THE INVENTION

### 1. Field of the Invention

Object of the present invention is an automated columns system for vertical warehouses for storing and retrieving materials. The columns system, according to the present invention, can be used, by way of example and not limited to, in the “automotive” logistics sector.

### 2. Brief Description of the Prior Art

At the state of the art, in the logistics of production systems, ergonomic vertical warehouses, in which materials, semi-finished products or goods can be stored and retrieved as required, are known.

A known example of a vertical warehouse comprises a plurality of columns which, facing each other, allow the positioning of supports or shelves where the components to be stored can be placed. The minimum number of columns for a vertical warehouse is two, preferably four, but this number obviously varies according to the type of warehouse. The use of vertical warehouses makes it possible to realize a long series of benefits, among which the following should be mentioned: the optimization of space utilization, both vertical and horizontal; the possibility of increasing the frequency of hourly picking and storage operations; the reduction of errors during picking and storage operations; greater safety and improved ergonomics for warehouse operators; better protection of components and easier monitoring of stored components; easier handling of components; the possibility of integrating and connecting the vertical warehouse with company management information systems, for example, with an “Enterprise Resource Planning” (ERP).

Known warehouses have the disadvantage that they require handling mechanisms, such as hydraulic or electronic mechanisms, for each column and therefore require the presence of several operators and a synchronization between the movements of the individual columns to be managed by an operator. This makes the components handling process long and laborious.

In addition, the columns according to the known technique have the possibility of moving the supports only downhill. In other words, the movement of the supports, with which each column is equipped and on which the components are placed, only takes place in the downward direction. In fact, it is difficult to move in the opposite direction, i.e., upwards, as the transmission mechanisms must overcome the weight force (of the supported components) weighing on the column supports. Therefore, in the known columns, the upward motion of the supports is always carried out with unloaded supports. Therefore, there is a need to define an automated column system that is free from the above-mentioned drawbacks.

### SUMMARY OF THE INVENTION

The aim of the present invention is therefore an innovative automated column system for vertical warehouse applications. The aim is achieved by designing the column system in such a way that the movement of the columns is automatically synchronized. The synchronization takes place by means of a plurality of joints controlled by a pneumatic/electrical or mechanical drive. In addition, according to a further aspect of the present invention, an innovative motion transmission system allows the inversion of the motion of the column supports and the possibility of moving the supports even uphill in the presence of a load on them, making the column system not only automated but also ergonomic. These and other purposes and advantages are achieved, according to the invention, by an innovative automated column system for vertical warehouses, having the features set forth in the appended independent claim.

Further preferred and/or particularly advantageous embodiments of the invention are described according to the features disclosed in the appended dependent claims.

### BRIEF DESCRIPTION OF THE DRAWINGS

The invention will now be described with reference to the appended drawings, which illustrate a non-limiting example implementation, wherein:

FIG. 1 is a plan view of an automated columns system, according to an aspect of the present invention,

FIG. 2 is a side view of the column, according to an embodiment of the present invention,

FIG. 3 is a front view of the column of FIG. 2,

FIG. 4 is an enlarged scale detail of the lower portion of the column of FIG. 2,

FIG. 5 is an enlarged scale detail of the upper portion of the column of FIG. 2,

FIG. 6 is a perspective view of an automated and ergonomic columns system, according to a further aspect of the present invention,

FIG. 7 is a view of a first column of the column system of FIG. 6, said first column being equipped with a damper element and an element for activating the upward phase, and

FIG. 8 is a view of a second column of the column system of FIG. 6, equipped with a lever mechanism for the automatic operation of the downward phase.

### DETAILED DESCRIPTION OF THE INVENTION

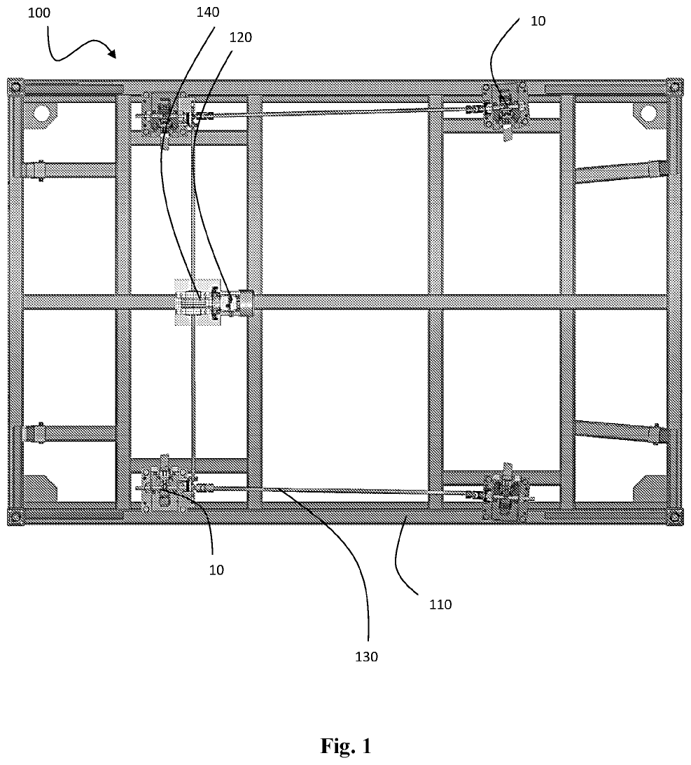

With reference to FIG. 1, a system of automated columns is indicated with the reference 100, according to a first aspect of the present invention. The system is suitable for vertical warehouses, used for the storage and the transport of industrial products. The automated columns 10 must be at least two in number and facing each other, but according to a preferred embodiment illustrated in FIG. 1 they are four in number. Naturally, if the logistics of the warehouse requires it, the number of columns may also be higher, for example six or eight, as long as they are always even in number.

The automated columns 10 can be connected to each other according to the need and the type of product to be stored or transported, by means of a framed structure 110, which preferably takes the shape of a parallelepiped configuration in the three directions of the space.

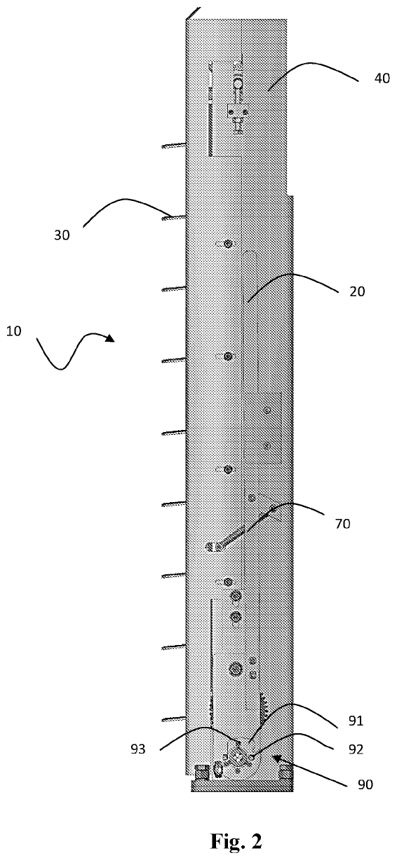

At the center between the columns 10 there may be a pneumatic or electric gear motor 120 preferably powered at 24 volts and connected to a number of mechanical transmissions, preferably cardan joints 130, equal to the number of columns 10. In the example of FIG. 1 this number is four. The use of the central pneumatic/electrical gear motor 120 and the mechanical transmissions allows all four columns 10 to be operated simultaneously. The control of the gear motor can be automated remotely. With reference to FIG. 2, as an alternative to the pneumatic/electrical gear motor, the columns 10 are operated by means of two pairs of pedals (of known type and therefore not shown in the figure), a first pair of pedals on one side of the framed structure 110, a second pair of pedals on the opposite side. For each pair of pedals, a first pedal activates the supports of the columns 10 upwards, while the second pedal activates the supports of the columns 10 downwards. The presence of two pairs of pedals is linked to the fact that the columns must move two by two clockwise (a first pair) and counterclockwise (a second pair facing the first pair) to perform the same upward or downward movement of the supports carrying the components.

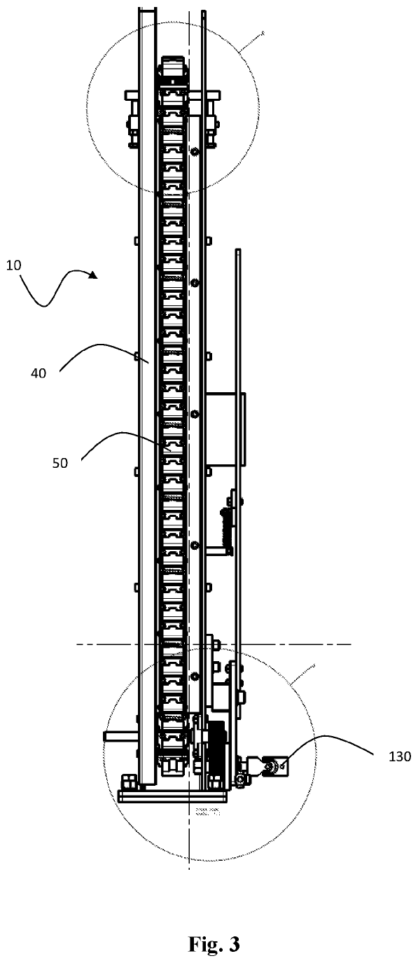

According to a further embodiment of the invention and with reference to FIG. 2, the columns 10 are operated by means of two pairs of levers 20, a first pair of levers on columns 10 of one side of the framed structure 110, a second pair of levers on columns 10 of the opposite side. For each pair of levers, a first lever activates the supports of the columns 10 upwards, while a second lever, mounted symmetrically with respect to the first one, activates the supports of the columns 10 downwards. The presence of two pairs of levers is linked to the fact that the columns must move two by two clockwise (a first pair) and anticlockwise (a second pair facing the first pair) in order to perform the same upward or downward movement of the supports carrying the components. Still with reference to FIG. 2, each of the automated columns 10 comprises a box structure 40 with an almost square cross-section, fixed to a base plate and formed by two vertical side walls in stainless steel or aluminum or similar. In the same FIG. 2, a plurality of supports 30 moved by a transmission member 50 (visible in FIG. 3) are shown. The supports 30, in turn, move the components of the vertical warehouse. The transmission member 50, for example a chain 50, according to known technique comprises a plurality of dowels which are fixed by means of rivets to the central structure of the chain. The chain 50 can accommodate a variable number of supports 30 capable of supporting the components (goods, general cargo, etc.) that will be loaded by the operator onto the vertical magazine.

Supports 30 are advantageously made of polyethylene (or polyzene), which is a very light material and widely used in a wide variety of industries. It is used for the production of equipment for the chemical industry, bins and containers, slides and sliding elements, sliding guides and the like. The advantage of using polyzene instead of traditional steel is that it is highly resistant to chemical agents, water, salt solutions, acids, alkalis, alcohol and petrol. In addition, polyzene is a material with high impact strength (even at low temperatures) and low friction coefficient, with excellent non-stick properties.

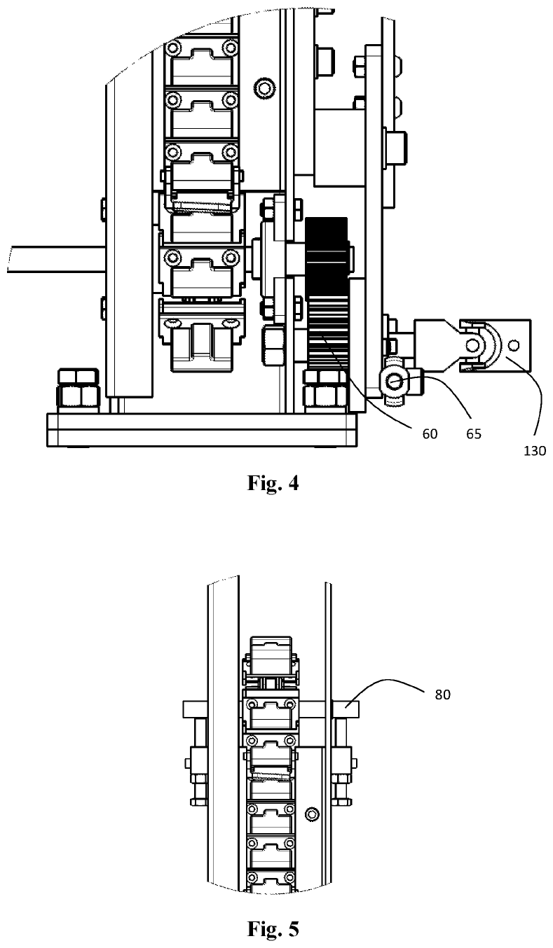

With reference to FIGS. 2 to 5, the motion of the supports 30 of the columns 10 is realized as follows. The control of the pneumatic/electrical gear motor 120, by means of the cardan joints 130, as well as the control of the pedal or of the lever 20, is transmitted to a lower gear 60, preferably constituted by a pinion-crown coupling. From the lower gear assembly 60 by means of a lever system 70, motion is transferred to an upper gear assembly 80. The lower and upper gear assemblies are coupled to the transmission member (preferably the chain 50) that moves the supports 30. The lever system 70 has the function of synchronizing the pitch of each automated column 10 during the loading of the elements by the operators.

A drum assembly 90 comprising a drum 91 and a double plurality of spring pins 92, 93 is positioned in proximity to the lower gear assembly 60, the first plurality of spring pins 93 being of greater length than the second plurality of spring pins 92. This double plurality of spring pins 92,93 has the function of determining the pitch of the drum 91 and, consequently, the advancement of the supports 30 mounted on the chain 50, when components are loaded onto the supports 30 by the operator of the vertical warehouse. According to a preferred form of implementation, the pitch of the drum 91 calculated in millimeters is determined by varying one or more spring pins so as to change the transmission ratio of the lower gear assembly 60. The feasible pitches are preferably: 25 mm, 50 mm, 75 mm, 100 mm and 200 mm.

In the case of mechanical actuation by means of a pedal or lever, a counter for the number of pieces is set to trigger a stop limiter 140. In the case of pneumatic or electrical drive, the pieces are counted automatically and the pneumatic or electrical drive will stop at the set time. The operation of the automated column 10 is as follows: the supports 30 move from the top to the bottom (and vice versa, as we shall see below), according to the pitch set on the drum assembly 90 and, once they reach the height of the lower gear assembly 60, they rotate downwards, hiding inside the automated column 10.

The operator has the possibility to manually stop the downward motion of the supports 30 by acting on the stop limiter 140. The stop limiter will block the movement of the chain 50 preventing a further downward motion of the supports 30. Moreover, the present invention, as will be better explained below, allows the columns to be moved both upward and downward, contrary to what happens in the case of the columns according to the known technique which have the possibility to move only downward. In fact, as already mentioned, the columns support the components to be stored or handled by means of a plurality of supports. Such supports need to be moved either upwards or downwards, depending on the handling requirements.

The present invention makes it possible to move the supports 30 upwards even if they are under load with the components resting on them. The problem of overcoming the weight force of the components during upward movement is solved by adopting a suitable transmission ratio between a bevel gear pair 65, located near the lower gear assembly 60, and between the pinion and the crown gear of the lower gear assembly 60. The overall gear ratio is chosen so as to reduce the speed and increase the transmissible torque to overcome the weight of the components on the supports 30.

The reversal of the motion is realized thanks to the relative positioning between the lever 20 and the lever system 70: depending on their relative position, one direction of rotation of the chain or the opposite direction can be realized. This is a peculiar feature of the invention not found in examples of columns in the state of the art.

The columns can be inclined in order to vary the useful load length and to accommodate complexly shaped components that may therefore not interpenetrate and/or hinder each other. Advantageously, the inclination of the columns can be up to 35° in relation to a vertical axis.

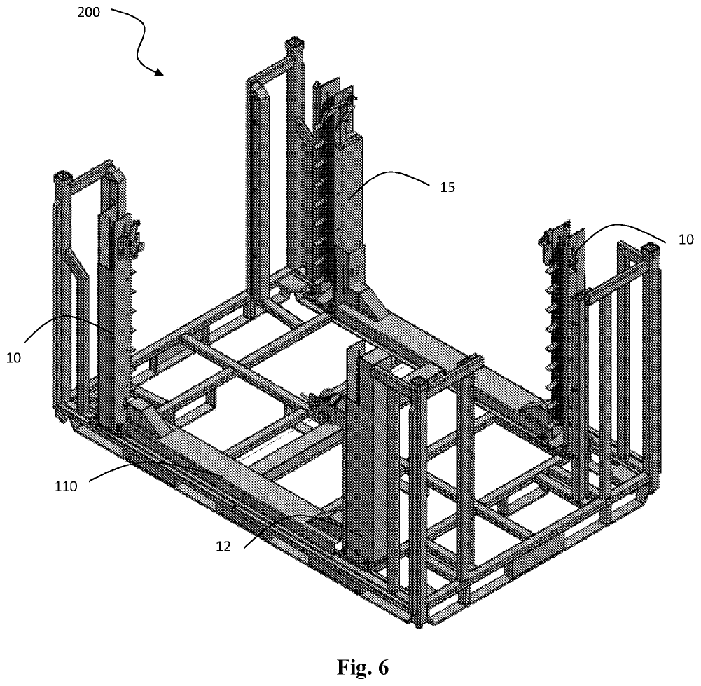

With reference to FIGS. 6 to 8, according to a further aspect of the present invention, the system of automated columns 200 is described according to a preferred embodiment. In this case too, the columns are four in number but also in this case their total number may be even greater, as long as it is an even number.

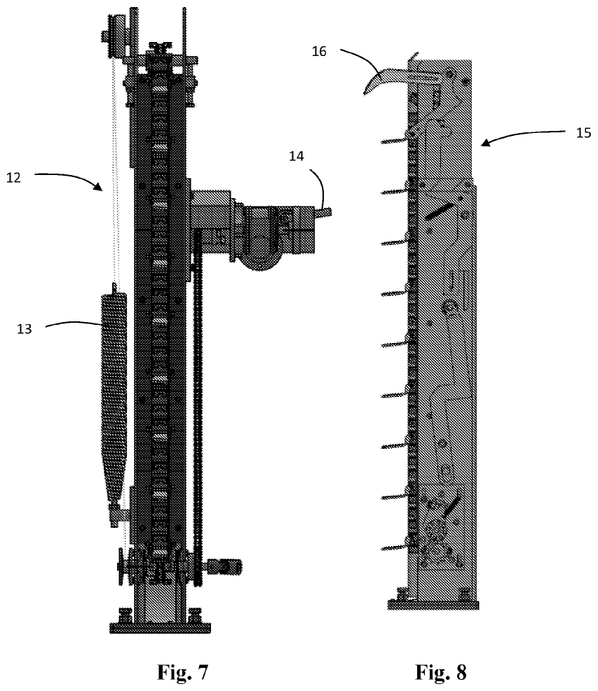

Two columns 10 made as described above are allocated at a first pair of opposite vertices along a first diagonal of the framed structure 110. At a second pair of opposite vertices along a second diagonal of the framed structure 110 there are instead two columns with further characteristics. A first column 12 is provided with a damper element 13 for braking the downward motion of the supports 30 during the loading phase. The damper element may be, by way of example only, a helical spring with variable stiffness, as in the example of FIG. 7 which shows a shot-blasted and double-tapered spring, or a helical spring coupled to a hydraulic piston. The first column 12 also comprises a crank 14 for activating the upward phase of the supports 30. The upward movement is therefore achieved by means of the crank 14 which has the task of bringing the last component always in the unload position. A second column 15 is equipped with a lever system 16 for the automatic operation of the downward phase of the supports 30.

The downward motion operability is available either by means of the lever mechanism 16, designed to be activated automatically by the positioning of the component, or by a handle (of a known type and therefore not shown in the figure) for manual operation.

Therefore, the great advantage of the invention according to this further aspect, with respect to the above disclosed one, is that the supports 30 do not have to perform a circular motion passing from the downward phase to the upward phase, but the same two phases are operated independently by means of the lever mechanism 16 and the crank 14 or, alternatively, by means of the handle and the crank 14. The same system can be operated with a pneumatic/electric gear motor as the one described according to the first aspect of the present invention. The transmission ratio can reach up to 1:20.

The columns are connected to each other by means of mechanical transmission members, preferably cardan joints 130 such as those described in FIG. 1, which allow the synchronized motion to be transmitted to all the columns. The same motion created by a column and transmitted to all the others acts both downward and upward. Therefore, according to this further aspect, for a mechanical drive, the invention does not require two pairs of pedals or two pairs of levers, but a crank for the upward motion and a lever mechanism (or a handle) for the downward motion.

All the columns, the standard ones 10, the first column 12 and the second column 15, have the possibility, if necessary, to be mounted misaligned with each other with an offset angle of up to 30°, thanks to the fact that the use of cardan joints allows the recovery of such misalignments. The maximum dimension of the columns has been reduced from 145 mm to 120 mm. In this configuration too, an end stop is provided as in the previously described configuration. The supports 30 have been optimized by increasing their width up to 72 mm (compared to the 30 mm of other known embodiments) in order to increase the resistant section and avoid deflections in the presence of heavy loads. The supports are guaranteed for a load up to 25 kg/cm.

In this configuration too, the achievable steps are preferably: 25 mm, 50 mm, 75 mm, 100 mm and 200 mm. All forms of implementation have been studied and implemented with the concept of flexibility, ductility and modularity: in fact, the column system is modular according to the need and can be readjusted, with simple quick measures, to new products.

Although at least one exemplary embodiment has been presented in the summary and detailed descriptions, it must be understood that there are a large number of variants falling within the scope of protection of the invention. Furthermore, it must be understood that the embodiment(s) presented are merely examples which are not intended to limit in any way the scope of protection of the invention or its application or configurations. Rather, the summary and detailed descriptions provide a convenient guide for the skilled person in the art to implement at least one exemplary embodiment, it being clear that numerous variations can be made in the function and assembly of the elements described herein, without exceeding the scope of protection of the invention as set forth in the appended claims and their technical-legal equivalents.

1. A system (100, 200) of automated columns for a vertical warehouse comprising:
a plurality of automated columns (10) integrally connected to a framed structure (110), the number of columns (10) being always even, each of said plurality of automated columns comprising in turn a transmission member (50) which rotates around an upper gear assembly (80) and a lower gear assembly (60) and a plurality of supports (30), supported by the transmission member (50), which translate from top to bottom and vice versa by the rotational movement of the transmission member (50),
a pneumatic/electrical or mechanical drive
a plurality of mechanical transmissions (130) in a number equal to the number of columns (10),
wherein:
the pneumatic/electrical or mechanical drive and mechanical transmissions (130) synchronize the upward or the downward movement of the plurality of supports (30) that support corresponding components to be stored,
the plurality of mechanical transmissions comprises a corresponding plurality of cardan joints (130),
a first column (12) of the plurality of columns (10) is provided with a damper element (13) for braking the downward motion of the supports (30) during the load step of the components to be stored,
the system (100) of automated columns being characterized in that
the damper element (13) is a helical spring with variable stiffness, provided with a double taper.

2. (canceled)

3. (canceled)

4. The system (200) according to claim 1, in which the first column (12) includes a crank (14) which operates the mechanical drive of the upward motion of the supports (30).

5. The system (200) according to claim 1, in which a second column (15) of the plurality of columns (10) is provided with a lever mechanism (16) for the automatic mechanical actuation of the downward motion of the supports (30).

6. The system (200) according to claim 1, wherein a second column (15) of the plurality of columns (10) is provided with a handle for the mechanical actuation of the downward motion of the supports (30).

7. The system (200) according to claim 1, wherein the first column (12) and the second column (15) are positioned on a pair of opposite vertices along a diagonal of the framed structure (110).

8. The system (100, 200) according to claim 1, in which the pneumatic/electrical drive is operated by means of a pneumatic/electrical gear motor (120).

9. The system (100, 200) according to claim 1, wherein the plurality of automated columns (10) assumes an inclination with respect to a vertical axis up to 35°.

10. The system (100, 200) according to claim 1, further comprising a counter for the number of components resting on the plurality of supports (30) configured in such a way as to trigger an end stop (140).

11. The system (100, 200) according claim 1, wherein one or more columns of the plurality of columns (10) is positioned misaligned with respect to the other columns (10) with an offset angle ranging from 0° to 30°.
